(19) United States
(12) Patent Application Publication
(10) Pub. No.: US 2004/0213266 A1
(43) Pub. Date: Oct. 28, 2004

(54) Network switch fabric configured to weight traffic

(75) Inventors: Nelson Willhite, Sunnyvale, CA (US); Mike Noll, San Jose, CA (US); Robert Steven Martin, Los Gatos, CA (US); Akhil Duggal, Los Altos, CA (US); Craig Lindberg, Nevada City, CA (US); Thomas Carleton Jones, San Jose, CA (US); Srinivas Komidi, San Jose, CA (US)

Correspondence Address: VAN PELT & YI LLP, 10050 N. FOOTHILL BLVD #200, CUPERTINO, CA, 95014, US

(73) Assignee: Alcatel IP Networks, Inc.

(21) Appl. No.: 10/831,720

(22) Filed: Apr. 23, 2004

Related U.S. Application Data
(60) Provisional application No. 60/465,652, filed on Apr. 25, 2003.

(51) Int. Cl. H04L 12/28; H04L 12/56

(52) U.S. Cl. 370/395.43; 370/412

(57) ABSTRACT

Network traffic switching comprises: for each of a plurality of classes, specifying a next queue to be serviced within that class, selecting from among the classes a next class to be serviced, and sending data from the next queue of the next class to be serviced via an egress link.

### CROSS REFERENCE TO RELATED APPLICATIONS

This application claims priority to U.S. Provisional Patent Application No. 60/465,652 entitled NETWORK SWITCH AND FABRIC ACCESS ARCHITECTURE filed Apr. 25, 2004, which is incorporated herein by reference for all purposes.

### FIELD OF THE INVENTION

The present invention relates generally to networking systems. More specifically, a technique for providing multiple levels of service is disclosed.

### BACKGROUND OF THE INVENTION

In data communication networks, devices such as routers and switches are often used to transfer data from a source to a destination. Existing switching systems typically employ a switch fabric that switches data from source ports (also referred to as input ports) to destination ports (also referred to as output ports). The source ports are typically given equal access to each destination port. For example, in a switch fabric where each destination port is configured to receive data from three source ports, each of the three source ports typically has equal access to the destination port. Such equal access may result from the fact that frames from all sources to a particular destination are placed in a single queue or buffer, such as a FIFO, and serviced in the order received.

While the typical switch design is useful for systems that offer equal access to all source ports, sometimes it may be desirable to allow some of the source ports to have more bandwidth access than others. For example, a system operator may wish to offer different levels of services where certain customers receive a greater amount of bandwidth than others. In some cases, it may be desirable to provide different guarantees for different classes of service (e.g., different priority levels), and/or by source-destination pair (e.g., by IP flow). It would be desirable if a switch fabric can be configured to support such service level agreements. It would also be useful if the configuration is flexible so that the service levels can be reconfigured easily.

### BRIEF DESCRIPTION OF THE DRAWINGS

Various embodiments of the invention are disclosed in the following detailed description and the accompanying drawings.

FIG. 1 is a block diagram illustrating an embodiment of a switching system.

FIG. 2A is an architectural diagram illustrating a switch fabric embodiment.

FIG. 2B is a diagram illustrating a junction and its associated queue set, according to some embodiments.

FIG. 3 is a flowchart illustrating the processing of data according to certain embodiments.

FIG. 4 is a diagram illustrating the design of a switch circuit embodiment.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Dual level scheduling of network switch fabric destination ports to fulfill service level guarantees is disclosed. In some embodiments, data is classified into a plurality of classes, and a next queue to be serviced within each class is specified. A next class to be serviced is selected, and data from the next queue of the next class to be serviced is sent via an egress link. The selection of the queue and class may be performed according to certain schedules. The schedulers may be configured to fulfill certain service level agreements. In some embodiments, the schedulers are dynamically configured based on observation of the incoming traffic.

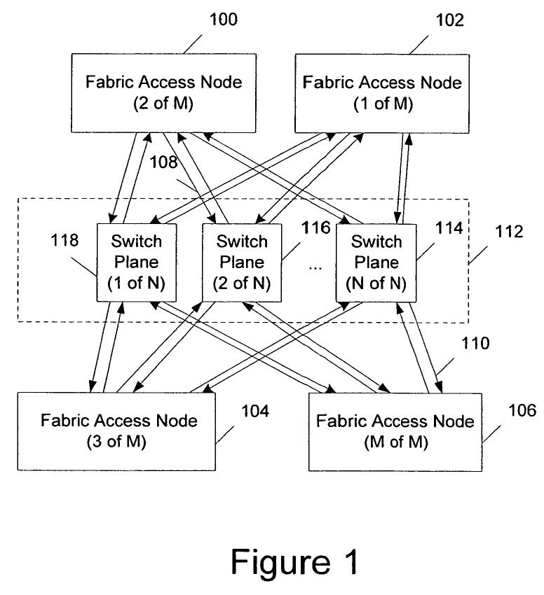

FIG. 1 is a block diagram illustrating an embodiment of a switching system. In this example, a number “M” of fabric access nodes, represented in FIG. 1 by fabric access nodes 100-106, are coupled to a switch fabric 112. Switch fabric 112 includes a plurality of “N” switch planes, represented in FIG. 1 by switch planes 114-118. For the purposes of example, in the following discussion, data packets are divided into cells and switched. Other units of measurements for data being transferred, such as packets, frames, cell segments, etc. may also be used. The lengths of the units may be fixed or variable.

Each of the switch planes can switch cells independently, without requiring synchronization with other switch planes. Each switch plane may be a separate physical device, although in some embodiments one physical device, e.g., one integrated circuit, may support multiple switch planes. Each fabric access node is associated with one or more ports that are connected to the switch plane via bi-directional connections such as 108 and 110. As used herein, a port refers to a logical source or destination that can be addressed for the purposes of transferring data. Data is transferred from a source port to a destination port via the bi-directional connections. A link used to transfer data from an input (source) port to the switch fabric is referred to as an ingress link, and a link used to transfer data from the switch fabric to an output (destination) port is referred to as an egress link. In the example shown, a port is serviced by an ingress-egress link pair. A port may also be serviced by several link pairs that are bundled. The actual number of access nodes, switch planes, ports, as well as the number of links used to serve the ports depend on implementation and may vary for different embodiments.

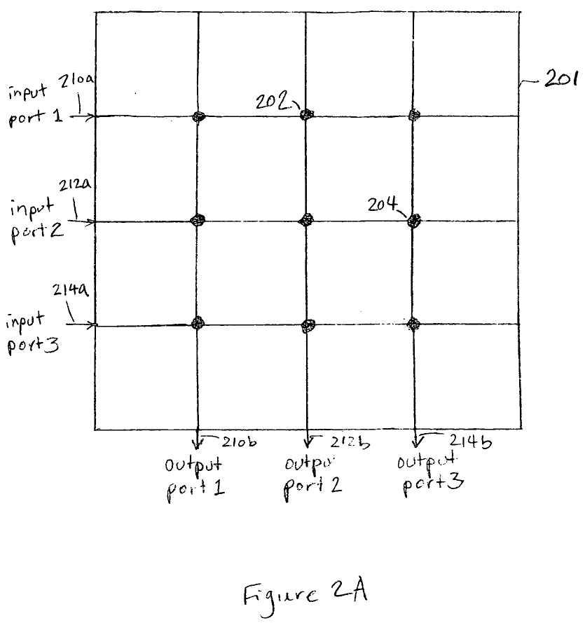

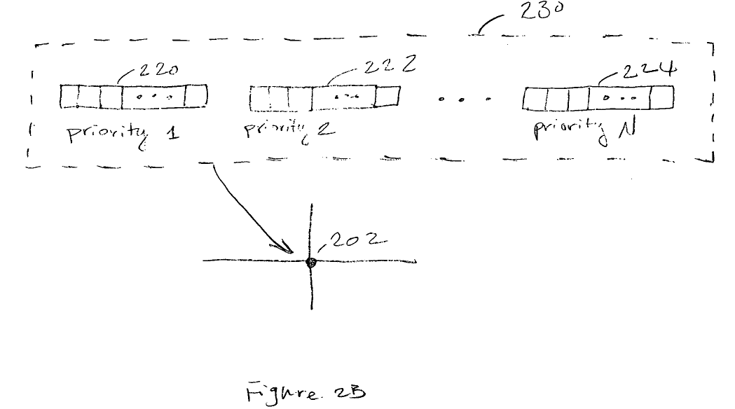

FIG. 2A is an architectural diagram illustrating a switch fabric embodiment. In this example, switch device 212 allows data to be switched between a plurality of ports. Three ports numbered 1-3 are shown, although the number of ports may vary for other embodiments. The ports can both send and receive data. In other words, each port functions both as an input port (also referred to as a source port) from which data originates and as an output port (also referred to as a destination port) to which data is sent. Thus, the input ports and the output ports are shown separately and the association between an input port and an output port is indicated by the shared numerical portion of their labels (e.g. input port 1 associated with ingress link 210a and output port 1 associated with egress link 210b are the input-output port pair of the same logical port 1). Data originating from input ports 1, 2 and 3 are sent to the switch device via ingress links 210a, 212a and 214a, respectively.

The switch device 201 is represented as a cross-bar structure through which data received on an ingress link may be sent to an appropriate egress link by being switched to the egress link at one of the junctions indicated by the large black dots marking the intersection points of the cross-bar, such as junctions 202 (providing a path from ingress link 210a to egress link 212b) and 204 (providing an input path from ingress link 212a to egress link 214b). Although each ingress link is connected to every other egress link in the embodiment shown, in some embodiments (such as embodiments with bundled links), an ingress link may be connected to fewer than all the available egress links.

In some embodiments, a service level agreement is established to guarantee a predetermined amount of bandwidth for certain types of traffic. The service level agreements may be implemented using priority levels. In some embodiments, a higher priority level is given to customers who subscribe to the premium service. In some embodiments, for the same customer, a higher priority level is given to traffic that is deemed more important (for example, a bank may assign a higher priority level to wire transfer traffic than email traffic). Service level guarantees may also be given based on destination or source-destination pairs (e.g., by IP flow). For example, a customer may be willing to pay more for a guarantee level of bandwidth between two systems that exchange a high volume of critical data over the network served by the switch.

In some embodiments, at each junction of the cross bar structure shown in FIG. 2A, input data is classified and buffered in a queue set associated with the junction and class. Each junction may have one or more queues, depending on how many classes of traffic are defined or supported. Each junction is associated with the logical source port associated with the corresponding ingress link and the logical destination port associated with the corresponding egress link. Therefore, each junction includes one or more queues, each associated with the source-destination pair with which the junction is associated, and each associated with its respective class of traffic. For the purpose of example, embodiments in which data is classified according to service priority levels are discussed throughout the specification, although other classification criteria may be applicable as well. FIG. 2B is a diagram illustrating a junction and its associated queue set, according to some embodiments. In this example, the system maintains N different priority levels. Each cell being transferred is classified according to its priority level, which corresponds to a value between 1 to N. Junction 202 of the switch device is associated with a queue set 230 that includes N queues corresponding to the N priority levels. Similarly, other junctions of the switch device are each associated with a like queue set. Referring to FIG. 2A, one can see that the queue set 230 of FIG. 2B, which is associated with junction 202, is associated with input (source) port 1 and output (destination) port 2. The incoming data cells are buffered in a queue with matching priority level, and then serviced according to a prescribed scheduling process. Details of how the queues are serviced are discussed below.

Several different methods may be employed to classify the cell. In some embodiments, each cell includes an identifier that can be used to determine the cell's classification. For example, a flag or other value in the header may be used to indicate the priority level of the data unit. In some embodiments, the cell's content is examined to determine its classification. For example, some systems allow different service levels to be set for various source/destination address combinations. Such systems may classify cells according to their source addresses and/or destination addresses (e.g., by IP flow).

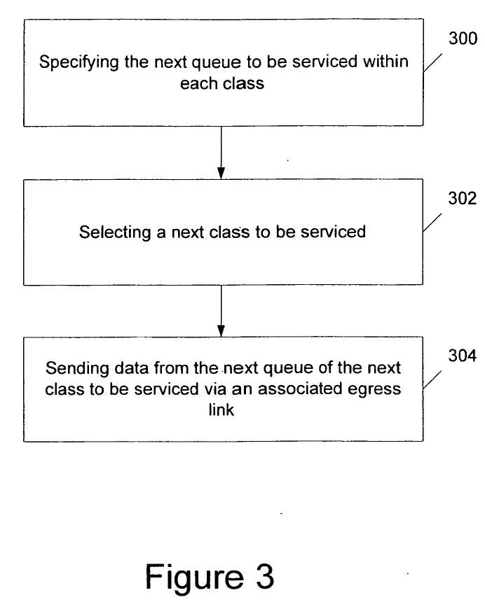

FIG. 3 is a flowchart illustrating the processing of data according to certain embodiments. In this example, input data is classified into several classes based on the priority level of the data. Data from a source port may be classified into several classes (based on, for example, the address associated with the data) and buffered in appropriate queues. As a result, each class includes data queues that are associated with different source ports and have the same priority level. During the operation, the next queue to be serviced within each class is specified (300). Referring to FIG. 2A, an instance of the process shown in FIG. 3 may be implemented for each egress link 210b, 212b, and 214b. For each egress link, each of the junctions associated with the egress link may have associated with it a plurality of queues of different priorities for the source associated with the junction. In some embodiments, step 300 comprises specifying as between the queues of the same priority from the junctions associated with the egress link (e.g., between the priority 1 queue associated with source port 1 for egress link 210a, the priority 1 queue associated with source port 2 for egress link 210a, and the priority 1 queue associated with source port 3 for egress link 210a) the next queue from that class to be serviced (i.e., which source port's priority 1 queue will be serviced the next time a priority 1 queue is serviced for that egress link). The next class to be serviced is selected (302). Data is then sent from the next queue of the next class to be serviced via the associated egress link to the associated destination port (304). The processing logic may be implemented in several different ways, including software or firmware code executed by a processor, application specific integrated circuit, logic circuitry that is a discrete component or a part of the switch circuit, or any other appropriate processing component.

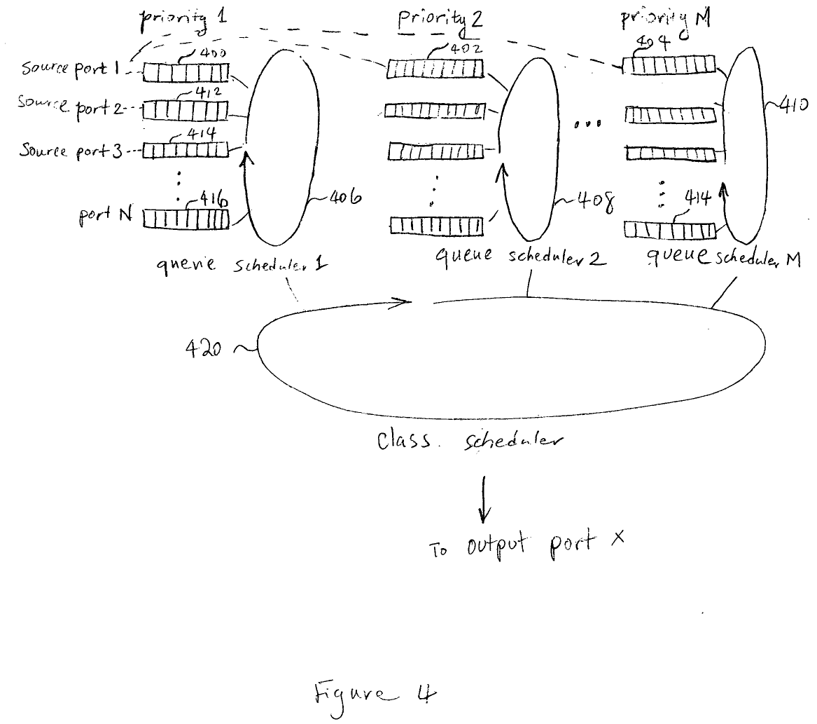

FIG. 4 is a diagram illustrating the design of a switch circuit embodiment. In this example, data designated for an output port X is classified based on the source port from which the data originated. Such classification allows different levels of services to be provided to different service subscribers, as well as to provide different services levels for different destinations. For example, a subscriber may set all of the traffic originating from the subscriber site to be of the highest priority and obtain the best guaranteed service; alternatively, the subscriber may grant higher priority to certain important addresses or domains, and set lower priority for the rest, thus achieving cost savings.

Data from a source port (such as input port 1) is stored in M priority queues (such as 400-404) that correspond to priority levels 1-M. Queues associated with different ports and of the same priority level form a class. For example, queues 400, 412, 414 and 416, associated with source ports 1, 2, 3 and 4 respectively and all of priority level 1, collectively form a class. Each class has a corresponding scheduler configured to determine which one of the queues within the class is to be served next. In the example shown, classes of priority 1, 2 and M correspond to schedulers 406, 408 and 410, respectively. The schedulers operate independent of each other. In some embodiments, the queue schedulers employ a weighted round robin scheduling algorithm, where the frequency with which a queue associated with a particular source port is serviced relative to other queues in the same class depends on the weight assigned to the source port. Various scheduling algorithms may be used by the schedulers.

A class scheduler 420 determines and selects the next class to be serviced. Once a class is selected, data from the next queue of the selected class is sent to output port X via the egress link associated with the scheduling process shown in FIG. 4. Scheduler 420 may employ various scheduling algorithms such as round robin, weighted round robin, or any other appropriate algorithm.

For example, at a certain point in time, the queue schedulers determine that the next queues to be serviced within priority classes 1, 2 and M correspond to queues 412, 402 and 414, respectively. Once class scheduler 420 determines that priority class 1 is to be serviced next, data from queue 412 is sent via the egress link to output port X. Similarly, when priority class 2 or priority class M is selected by scheduler 420, queue 402 or 414 is serviced. Class scheduler 420 may weight its selection based on the priority of the class. For example, it may be configured according to a weighted round robin algorithm to spend thirty percent of the time servicing priority class 1, twenty percent servicing priority class 1, five percent servicing priority class M, etc.

By adjusting the weights of the queue and class schedulers, certain types of data (such as data from a particular source port to a particular destination port at a certain priority) can be configured to be guaranteed to have a prescribed amount of bandwidth. The adjustment is illustrated by the following example in which a switch fabric includes N input ports and an output port with a bandwidth of K. For the sake of simplicity, assume that there are two priority levels and the class scheduler implements a weighted round robin algorithm with a weight of W for priority level 1 and a weight of 1 for priority level 2 (i.e. the scheduler spends W/(W+1) of the time servicing priority level 1 and 1/(W+1) of the time servicing priority level 2). Also assume that the queue scheduler for priority level 1 implements a weighted round robin algorithm, with a weight of S for source port 1 and a weight of 1 for the rest of the source ports. The relationship between the variables may be expressed as the following:

$$\frac{S}{S + ( N - 1 )} = \frac{G}{K \cdot \frac{W}{W + 1}}$$

where G is the bandwidth desired to be guaranteed for the source port associated with the weight S, i.e., source port 1 in the example described above.

The value of a weight may be chosen by setting the other variables and solving the equation. The equation may be applied to, for example, a system with 32 input ports (N=32) and an output bandwidth of 10 Gigabits (K=10). Assume the objective is to guarantee 1 Gigabits of bandwidth for servicing priority level 1 data from input port 1. Further assume the weight assigned to priority 1 traffic, W, is equal to 4. Solving the above equation yields a source port weight S equal to approximately 4.429. Other W values may also be used to obtain different S. Similar relationships may be derived for systems with different variables.

For example, for any given source port and priority, a source weight Sᵢ and a class weight Wⱼ may be assigned, with the relationship between the respective weights for any particular source-class pair, assuming 1 to N source ports and 1 to M classes (priorities) as in the example shown in FIG. 4, being given by the equation:

$$\frac{{S}_{i}}{{\sum }_{i = 1}^{N} {S}_{i}} = \frac{G}{K \cdot \frac{{W}_{j}}{{\sum }_{j = 1}^{M} {W}_{j}}}$$

In some embodiments, the above equation would be used to ensure that the source weights Sᵢ of the respective source ports and the class priorities Wⱼ are such that the service guarantee G is fulfilled with respect to each applicable destination.

In some embodiments, the service level agreements, the weights of the schedulers, as well as the priority levels can be adjusted dynamically. Since the bandwidth of the system is not utilized in full at all times, dynamic adjustments allow the system to assign bandwidth to various subscribers in a flexible manner and take advantage of the statistical nature of traffic data to more efficiently utilize the bandwidth. Over subscription can be more effectively handled. In some embodiments, the input traffic is observed (by, for example, a control processor or circuit) and the adjustments to the parameters of the queue scheduler and/or class scheduler are made in response to the observation. For example, a switch fabric with an output port that supports a maximum of 3 Gigabits of bandwidth may be configured to offer 1 Gigabits of the bandwidth to priority level 1 data originating from input port 1, and 500 Megabits of the bandwidth to priority level 1 data originating from input ports 2, 3, 4 and 5. If it is observed that there is only 100 Megabits of level 1 traffic originating from input port 1, however, there is 600 Megabits of level 1 traffic originating from each of the other input ports, the weights of the queue scheduler for level 1 traffic and/or the weights of the class scheduler may be adjusted so that the queue for input port 1 is serviced just often enough to guarantee 100 Megabits of traffic, and the other input ports are serviced more frequently to increase their bandwidth guarantee.

While the dual level scheduling described in the examples discussed in detail above involve scheduling by destination based on source and class, the approach described herein may be used to schedule a switch fabric destination port on a basis other than the source or class of the respective cells. More than two levels of scheduling may also be used.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of switching network traffic, comprising:
a) for each of a plurality of classes, specifying a next queue to be serviced within that class;
b) selecting from among the classes a next class to be serviced; and
c) sending data from the next queue of the next class to be serviced via an egress link.

2. A method of switching network traffic as recited in claim 1, wherein each class has associated with it one or more queues.

3. A method of switching network traffic as recited in claim 1, wherein each class has associated with it one or more queues and each of said one or more queues is associated with a physical source of data.

4. A method of switching network traffic as recited in claim 1, wherein each class has associated with it one or more queues and each of said one or more queues is associated with a logical source of data.

5. A method of switching network traffic as recited in claim 1, wherein each class has associated with it one or more queues and each of said one or more queues is configured to buffer data having an attribute associated with the queue.

6. A method of switching network traffic as recited in claim 5, wherein the data is determined to have the attribute associated with a particular queue by evaluating at least a portion of the data.

7. A method of switching network traffic as recited in claim 5, wherein the data is determined to have the attribute associated with a particular queue by reading a value in a header portion of a cell comprising the data.

8. A method of switching network traffic as recited in claim 1, wherein each class comprising the plurality of classes is associated with a different priority level.

9. A method of switching network traffic as recited in claim 1, further comprising repeating a)-c) to send more data via the egress link.

10. A method of switching network traffic as recited in claim 1, wherein the next queue to be serviced is specified according to a scheduling process.

11. A method of switching network traffic as recited in claim 1, wherein the next queue to be serviced is specified according to a weighted scheduling process.

12. A method of switching network traffic as recited in claim 1, wherein the next queue to be serviced is specified according to a weighted round robin scheduling process.

13. A method of switching network traffic as recited in claim 1, wherein the next queue to be serviced is specified according to a weighted round robin scheduling process having a plurality of weights, and wherein each of the plurality of weights is associated with a data source.

14. A method of switching network traffic as recited in claim 1, wherein the next queue to be serviced within a class is specified independently of other classes.

15. A method of switching network traffic as recited in claim 1, wherein the next class to be serviced is selected according to a scheduling process.

16. A method of switching network traffic as recited in claim 1, wherein the next class to be serviced is selected according to a weighted round robin scheduling process having a plurality of weights.

17. A method of switching network traffic as recited in claim 1, wherein the next class to be serviced is selected according to a weighted round robin scheduling process in which each of the plurality of classes is assigned a corresponding weight.

18. A method of switching network traffic as recited in claim 1, further comprising observing input from a plurality of sources and adjusting a parameter associated with a queue scheduling process in response to the observation.

19. A method of switching network traffic as recited in claim 1, wherein the next queue to be serviced is specified according to a queue scheduling process and the next class to be serviced is selected according to a class scheduling process; and wherein the queue scheduling process and the class scheduling process are configured to fulfill a service level agreement.

20. A network switch fabric system, comprising:
a plurality of queues;
a processing component coupled to the plurality of queues, configured to:
for each of a plurality of classes, specify a next queue to be serviced within that class;
select from among the classes a next class to be serviced; and
send data from the next queue of the next class to be serviced via an egress link.

21. A computer program product for switching traffic, the computer program product being embodied in a computer readable medium and comprising computer instructions for:
a) for each of a plurality of classes, specifying a next queue to be serviced within that class;
b) selecting from among the classes a next class to be serviced; and
c) sending data from the next queue of the next class to be serviced via an egress link.
